(19) United States
(12) Patent Application Publication
(10) Pub. No.: US 2015/0273879 A1
(43) Pub. Date: Oct. 1, 2015

(54) CONVEYOR DEVICE AND INKJET RECORDING APPARATUS

(71) Applicant: KYOCERA DOCUMENT SOLUTIONS INC., Osaka (JP)

(72) Inventors: Tomohisa SODA, Osaka (JP); Hidenori TAKENAKA, Osaka (JP); Jumpei HOBO, Osaka (JP); Masami FUJIHARA, Osaka (JP); Takeshi WATANABE, Osaka (JP)

(73) Assignee: KYOCERA DOCUMENT SOLUTIONS INC., Osaka (JP)

(21) Appl. No.: 14/674,760

(22) Filed: Mar. 31, 2015

(30) Foreign Application Priority Data
Apr. 1, 2014 (JP) 2014-075590

(51) Int. Cl. B41J 11/00

(52) U.S. Cl. CPC B41J 11/007; B41J 11/0085; B41J 11/0045

(57) ABSTRACT

A conveyor device is for installation opposite to a recording head in a recording apparatus. The conveyor device includes a conveyor belt and a suction section. The conveyor belt conveys a recording medium. The suction section includes a guide member through which a plurality of through holes pass. The guide member has a surface having a plurality of grooves therein and facing the recording head with conveyor belt therebetween. The respective through holes are located in the respective grooves. The grooves include a plurality of grooves that extend in a direction across a conveyance direction of the recording medium. The suction section sucks on the recording medium through the conveyor belt and the guide member.

### INCORPORATION BY REFERENCE

The present application claims priority under 35 U.S.C. §119 to Japanese Patent Application No. 2014-075590, filed Apr. 1, 2014. The contents of this application are incorporated herein by reference in their entirety.

### BACKGROUND

The present disclosure relates to a conveyor device provided in a recording apparatus and an inkjet recording apparatus including the conveyor device.

An inkjet recording apparatus is a commonly known type of recording apparatus. Inkjet recording apparatuses are widely used in machines such as printers, copiers, and multifunction peripherals due to their compactness, low cost, and low operating noise. Inkjet recording apparatuses are broadly classified as being either a line head or a serial head type.

A line head inkjet recording apparatus includes a conveyor device that conveys a recording medium. The conveyor device generally includes a conveyor belt. The conveyor device is located opposite to a recording head. The conveyor device holds a recording medium on the conveyor belt while conveying the recording medium. The recording medium is held on the conveyor belt by using static electricity to attract the recording medium or negative pressure to suck the recording medium.

The conveyor device includes a suction section that sucks on the recording medium through the conveyor belt. The conveyor belt has a plurality of suction holes perforated therein. The suction section includes a guide member through which a plurality of through holes pass. Each of the through holes passes through the guide member in a thickness direction thereof. The guide member supports the recording medium with the conveyor belt therebetween. The guide member has a plurality of grooves into a surface thereof that faces the conveyor belt. At least one through hole is located in a corresponding one of the grooves. The suction section creates negative pressure to suck air through the suction holes in the conveyor belt and through the grooves and the through holes in the guide member. Through the above, the recording medium is sucked onto the conveyor belt.

Unfortunately, a configuration such as described above suffers the following problem. That is, suction force for sucking on the recording medium may be insufficient, thereby causing the recording medium to lift up. Lifting up of the recording medium below the recording head may change a distance between the recording head and the recording medium to cause an image artifact. Also, a paper jam may be caused below the recording head. The recording medium can tend to lift up at edges thereof especially. The edges of the recording medium means edges thereof oriented perpendicularly to a conveyance direction of the recording medium.

A certain inkjet recording apparatus includes a conveyor belt having suction holes of which number density defers among regions of the conveyor belt in order to prevent the edges of the recording medium from lifting up. Specifically, the number density of the suction holes located in opposite end portions of the conveyor belt is higher than that of the suction holes located in a central portion of the conveyor belt. The opposite end portions of the conveyor belt are regions where the edges of the recording medium pass, while the central portion of the conveyor belt is a region between the opposite end portions of the conveyor belt.

### SUMMARY

A conveyor device according to an aspect of the present disclosure is for installation opposite to a recording head in a recording apparatus. The conveyor device includes a conveyor belt and a suction section. The conveyor belt conveys a recording medium. The suction section includes a guide member through which a plurality of through holes pass. The guide member is located opposite to the recording head with the conveyor belt therebetween. The suction section sucks on the recording medium through the conveyor belt and the guide member. The guide member has a surface having a plurality of grooves therein. The surface faces the recording head with the conveyor belt therebetween. The respective through holes are located in the respective grooves. The grooves include a plurality of grooves that extend in a direction across a conveyance direction of the recording medium.

An inkjet recording apparatus according to another aspect of the present disclosure includes a recording head and the conveyor device described above. The recording head ejects ink droplets.

### BRIEF DESCRIPTION OF THE DRAWINGS

FIG. 1 illustrates configuration of an inkjet recording apparatus including a conveyor device according to a first embodiment of the present disclosure.

FIG. 2 is a plan view illustrating a guide member according to the first embodiment of the present disclosure.

FIG. 3 is a cross sectional view illustrating a groove and a through hole of the guide member according to the first embodiment of the present disclosure.

FIG. 4 is a plan view illustrating a conveyor belt according to the first embodiment of the present disclosure.

FIG. 5A illustrates a positional relationship between a sheet and first grooves located in one of end portions of the guide member according to the first embodiment of the present disclosure.

FIG. 5B illustrates a positional relationship between a sheet and grooves located in one of end portions of a typical guide member.

FIG. 6 illustrates an example of a positional relationship between suction holes in the conveyor belt and edges of a sheet according to the first embodiment of the present disclosure.

FIG. 7 illustrates an example of a positional relationship between through holes in the guide member and edges of a sheet according to the first embodiment of the present disclosure.

FIG. 8 is a plan view illustrating the guide member according to the first embodiment of the present disclosure.

FIG. 9 is a plan view illustrating a variation of the guide member according to the first embodiment of the present disclosure.

FIG. 10 is a plan view illustrating another variation of the guide member according to the first embodiment of the present disclosure.

FIG. 11 is a plan view illustrating a variation of the conveyor belt according to the first embodiment of the present disclosure.

FIG. 12 is a plan view illustrating another variation of the conveyor belt according to the first embodiment of the present disclosure.

FIG. 13 is a plan view illustrating a guide member according to a second embodiment of the present disclosure.

### DETAILED DESCRIPTION

The following explains embodiments of the present disclosure with reference to the drawings. Elements that are the same or equivalent are indicated by the same reference signs in the drawings and explanation thereof is not repeated. The drawings are schematic illustrations that emphasize elements of configuration in order to facilitate understanding thereof. Therefore, in order that the elements can be easily illustrated in the drawings, properties of each of the elements, such as thickness, length, and number thereof, may differ from actual properties of the element. Also note that material properties, shapes, dimensions, and the like, described for each of the elements of configuration in the following embodiments, are only examples and are not intended to impose any particular limitations on the elements.

### First Embodiment

### Basic Configuration of Inkjet Recording Apparatus 1

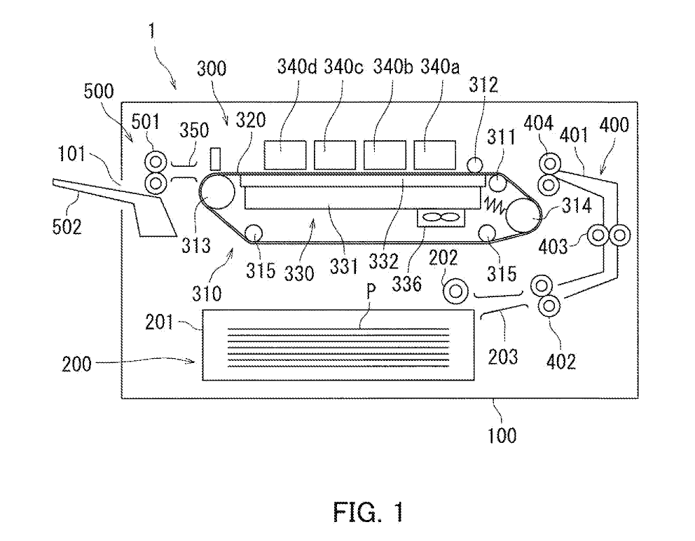

FIG. 1 illustrates configuration of an inkjet recording apparatus 1 including a conveyor device 310 according to a first embodiment of the present disclosure.

The inkjet recording apparatus 1 (an example of a recording apparatus) includes a housing 100, a sheet feed section 200, an image forming section 300 that uses an inkjet recording method, a sheet conveying section 400, and a sheet ejecting section 500. The sheet feed section 200 is located in a lower section of the housing 100. The image forming section 300 is located above the sheet feed section 200. The sheet conveying section 400 is located at one side of the image forming section 300. The sheet ejecting section 500 is located at the other side of the image forming section 300.

The sheet feed section 200 includes a sheet feed cassette 201 that is freely detachable from the housing 100. The sheet feed section 200 also includes a sheet feed roller 202 and guide plates 203. The sheet feed roller 202 is located above the sheet feed cassette 201 at one end thereof. The guide plates 203 are located between the sheet feed roller 202 and the sheet conveying section 400.

The sheet feed cassette 201 contains a plurality of sheets of paper P (an example of a recording medium) in a stacked state. In the following explanation, a sheet of paper is simply referred to as a sheet. The sheet feed roller 202 (a pickup roller) is a feed member that feeds the sheet P in the conveyance direction thereof. The sheet feed roller 202 picks up sheets P, one at a time, from the sheet feed cassette 201. The guide plates 203 guide the sheet P that has been picked up by the sheet feed roller 202 to the sheet conveying section 400.

The sheet conveying section 400 includes a sheet conveyance path 401 that is roughly C-shaped, a first pair of conveyance rollers 402 (a primary sheet feed roller pair), a second pair of conveyance rollers 403 (a secondary sheet feed roller pair), and a pair of registration rollers 404. The first pair of conveyance rollers 402 is located at an input end of the sheet conveyance path 401. The second pair of conveyance rollers 403 is located partway along the sheet conveyance path 401. The pair of registration rollers 404 is located at an output end of the sheet conveyance path 401. The sheet conveyance path 401 forms one section of a sheet conveyance path of the sheet P (an example of a recording medium conveyance path).

The first pair of conveyance rollers 402 is a feed member that feeds the sheet P in the conveyance direction thereof. The first pair of conveyance rollers 402 sandwiches the sheet P fed from the sheet feed section 200 therebetween and feeds the sheet P into the sheet conveyance path 401. The second pair of conveyance rollers 403 is also a feed member. The second pair of conveyance rollers 403 sandwiches the sheet P fed from the first pair of conveyance rollers 402 therebetween and feeds the sheet P in the sheet conveyance direction.

The pair of registration rollers 404 performs skew correction on the sheet P fed from the second pair of conveyance rollers 403. The pair of registration rollers 404 temporarily holds the sheet P stationary in order to synchronize conveyance of the sheet P with a timing at which image formation is to be performed on the sheet P. The pair of registration rollers 404 feeds the sheet P to the image forming section 300 in accordance with the timing of image formation on the sheet P.

The image forming section 300 includes a conveyor device 310, four types of line head 340a, 340b, 340c, and 340d, and a conveyance guide 350. The four types of line head 340a, 340b, 340c, and 340d are located above the conveyor device 310. The conveyance guide 350 is located downstream relative to the conveyor device 310 in terms of the conveyance direction of the sheet P. Although not illustrated in the drawings, each of the four types of line head 340a, 340b, 340c, and 340d includes a plurality of nozzles. The nozzles eject ink droplets to form an image, such as text or a diagram, on the sheet P. The image forming section 300 may also include a drying device. The drying device dries ink droplets that have landed onto the sheet P.

The conveyor device 310 includes a belt speed detecting roller 311, a sheet holding roller 312, a drive roller 313, a tension roller 314, a pair of guide rollers 315, an endless conveyor belt 320, and a suction section 330. The conveyor device 310 is located opposite to the four types of line head 340a, 340b, 340c, and 340d in the housing 100. The conveyor belt 320 is wound around the belt speed detecting roller 311, the drive roller 313, the tension roller 314, and the pair of guide rollers 315. The conveyor belt 320 conveys the sheet P.

The conveyor belt 320 is for example made from a material such as polyimide (PI), polyamide-imide (PAI), polyvinylidene fluoride (PVDF), or polycarbonate (PC). Use of polyimide or polyamide-imide is preferable in terms of reducing unevenness in thickness of the conveyor belt 320. Also, a layer made from a rubber material such as ethylene propylene diene monomer (EPDM) rubber may be layered on a rear surface of the conveyor belt 320 (i.e., a surface facing the suction section 330). The conveyor belt 320 has a thickness of, for example, 100 μm.

The tension roller 314 ensures that the conveyor belt 320 does not sag by applying tensile force to the conveyor belt 320. The conveyor device 310 may include a mechanism that when meandering of the conveyor belt 320 occurs, changes the orientation of the axial center of the tension roller 314 in accordance with the meandering. Such a mechanism corrects the meandering of the conveyor belt 320.

The belt speed detecting roller 311 is located upstream relative the suction section 330 in terms of the conveyance direction of the sheet P. The belt speed detecting roller 311 rotates due to friction generated between the belt speed detecting roller 311 and the conveyor belt 320. The belt speed detecting roller 311 includes a pulse plate (not illustrated) that rotates integrally with the belt speed detecting roller 311. The circulation speed of the conveyor belt 320 is detected by measuring the rotation speed of the pulse plate. Therefore, when unevenness in circulation speed of the conveyor belt 320 occurs, the unevenness can be corrected by controlling the rotation speed of the drive roller 313.

The drive roller 313 is located downstream relative to the suction section 330 in terms of the conveyance direction of the sheet P. Preferably the drive roller 313 is located such as to function in combination with the belt speed detecting roller 311 to maintain flatness of the conveyor belt 320. Such a configuration also maintains flatness of the conveyor belt 320 when meandering correction is performed on the conveyor belt 320.

The drive roller 313 is driven by a motor (not illustrated). In other words, the motor causes the drive roller 313 to rotate. When the drive roller 313 rotates, friction generated between the drive roller 313 and the conveyor belt 320 causes the conveyor belt 320 to circulate in a direction corresponding to counter clockwise in FIG. 1. The drive roller 313 has a diameter of, for example, 30.0 mm.

In a configuration in which correction of unevenness of speed of the conveyor belt 320 is performed by correcting rotation speed of the drive roller 313, the drive roller 313 preferably has a low moment of inertia. In other words, the drive roller 313 is preferably light. In consideration of the above, in the present embodiment the drive roller 313 is preferably a hollow pipe such as an aluminum pipe or a pipe having a three-spoke cross-section. In a configuration in which unevenness of speed of the conveyor belt 320 is not corrected, the drive roller 313 preferably has a large moment of inertia in order to stabilize rotation of the drive roller 313 through a flywheel effect. In other words, the drive roller 313 is preferably heavy. Therefore, in such a configuration the drive roller 313 is preferably made from a material such as solid metal.

In a configuration in which the conveyor belt 320 is made from a resinous material such as polyimide, a surface layer of the drive roller 313 is preferably made from a rubber material such as EPDM rubber, urethane rubber, or nitrile rubber. In a configuration in which the image forming section 300 forms an image on the sheet P using an aqueous ink, EPDM rubber is preferably used as a material of the surface layer of the drive roller 313 in order to prevent swelling of the rubber material. The surface layer made from the rubber material has a thickness of, for example, 1.0 mm. In a configuration in which a layer of a rubber material such as EPDM rubber is disposed over the rear surface of the conveyor belt 320, the surface layer of the drive roller 313 may be made from metal. In a configuration in which the surface layer of the drive roller 313 is made from aluminum, the surface of the drive roller 313 may be anodized in order to prevent abrasion.

The pair of guide rollers 315 is located lower than suction section 330. By positioning the pair of guide rollers 315 as described above, a space is formed under the suction section 330 and thus a section of the conveyor belt 320 that is located under the suction section 330 is prevented from coming into contact with the suction section 330. Also, a guide roller 315 among the pair of guide rollers 315 that is closer to the drive roller 313 maintains a degree to which the conveyor belt 320 is wound around the drive roller 313. A guide roller 315 among the pair of guide rollers 315 that is closer to the tension roller 314 maintains a degree to which the conveyor belt 320 is wound around the tension roller 314, thereby ensuring that meandering correction can be reliably performed.

The four types of line head 340a, 340b, 340c, and 340d are located in respective order from upstream to downstream in terms of the conveyance direction of the sheet P. The line heads 340a, 340b, 340c, and 340d each include a plurality of nozzles (not illustrated) that are arranged in a width direction of the conveyor belt 320 (i.e., a direction perpendicular to the conveyance direction of the sheet P). In other words, the inkjet recording apparatus 1 is a line head inkjet recording apparatus.

The following explains a generic line head inkjet recording apparatus. In order to eject ink droplets of a single color toward a recording medium, the line head inkjet recording apparatus includes a single recording head having a greater width than the recording medium. Alternatively, the generic line head inkjet recording apparatus may include a plurality of recording heads that are arranged in terms of a direction perpendicular to the conveyance direction of the recording medium (i.e., arranged in a width direction of the recording medium). In a configuration in which the inkjet recording apparatus ejects ink droplets of a plurality of different colors, the inkjet recording apparatus includes either a single recording head or a group of recording heads for each of the colors, and the recording heads for the respective colors are arranged in the conveyance direction of the recording medium. The recording heads are fixed in place and the recording medium is conveyed under the recording heads. The recording heads form an image on the recording medium by ejecting ink droplets onto the recording medium while the recording medium is being conveyed. Note that in a serial head inkjet recording apparatus, a recording medium is held stationary partway along a recording medium conveyance path and recording heads eject ink droplets onto the stationary recording medium while moving.

The following resumes explanation of the inkjet recording apparatus 1 according to the first embodiment. The line head 340a includes a plurality of nozzles that are each in communication with a pressure chamber (not illustrated) located within a recording head. The pressure chamber is in communication with an ink chamber (not illustrated) located within the recording head. The ink chamber is in communication with a black (Bk) ink tank (not illustrated) via an ink supply tube (not illustrated). In other words, the ink chamber is connected to the black ink tank.

The line head 340b includes a plurality of nozzles that are each in communication with a pressure chamber (not illustrated) located within a recording head. The pressure chamber is in communication with an ink chamber (not illustrated) located within the recording head. The ink chamber is in communication with a cyan (C) ink tank (not illustrated) via an ink supply tube (not illustrated). In other words, the ink chamber is connected to the cyan ink tank.

The line head 340c includes a plurality of nozzles that are each in communication with a pressure chamber (not illustrated) located within a recording head. The pressure chamber is in communication with an ink chamber (not illustrated) located within the recording head. The ink chamber is in communication with a magenta (M) ink tank (not illustrated) via an ink supply tube (not illustrated). In other words, the ink chamber is connected to the magenta ink tank.

The line head 340d includes a plurality of nozzles that are each in communication with a pressure chamber (not illustrated) located within a recording head. The pressure chamber is in communication with an ink chamber (not illustrated) located within the recording head. The ink chamber is in communication with a yellow (Y) ink tank (not illustrated) via an ink supply tube (not illustrated). In other words, the ink chamber is connected to the yellow ink tank.

The suction section 330 faces the rear surface of the conveyor belt 320 such as to be located opposite to the four types of line head 340a, 340b, 340c, and 340d with the conveyor belt 320 therebetween. The suction section 330 includes an air flow chamber 331 (an example of a gas flow chamber), a guide member 332 that covers an upper surface aperture of the air flow chamber 331, and a suction device 336. The guide member 332 supports the sheet P through the conveyor belt 320.

The sheet holding roller 312 is a driven roller. The sheet holding roller 312 is located opposite to the guide member 332 with the conveyor belt 320 therebetween. The sheet holding roller 312 guides a sheet P that has been fed from the pair of registration rollers 404 onto the conveyor belt 320 and causes the sheet P to be sucked onto the conveyor belt 320.

The sheet holding roller 312 preferably has a small moment of inertia in order to soften impact vibration generated by the sheet P impacting with the sheet holding roller 312. In other words, the sheet holding roller 312 is preferably light. The sheet holding roller 312 is for example preferably a hollow pipe such as an aluminum pipe or a pipe having a three-spoke cross-section. In a configuration in which the sheet holding roller 312 is made from aluminum, the surface of the sheet holding roller 312 may be anodized in order to prevent abrasion.

In the present embodiment, pressing force that presses the sheet holding roller 312 toward the conveyor belt 320 (i.e., toward the guide member 332) is applied to the sheet holding roller 312. Through the above configuration, even when there is a disparity between the conveyance speed of the sheet P by the pair of registration rollers 404 and the circulation speed of the conveyor belt 320, a position at which close contact between the sheet P and the conveyor belt 320 begins can be made to correspond to a position at which the sheet holding roller 312 is located.

The suction device 336 is for example a fan. However, the suction device 336 is not limited to being a fan and may for example be a vacuum pump instead. While the suction device 336 is being operated, the suction section 330 sucks on the sheet P through the conveyor belt 320.

The conveyance guide 350 guides the sheet P to the sheet ejecting section 500 upon the sheet P being ejected from the conveyor belt 320. The sheet ejecting section 500 includes a pair of ejection rollers 501 and an exit tray 502. The exit tray 502 is fixed to the housing 100 such as to project outward from an exit port 101 formed in the housing 100.

Once the sheet P has passed through the conveyance guide 350, the sheet P is fed toward the exit port 101 by the pair of ejection rollers 501 and is guided onto the exit tray 502. As a result, the sheet P is ejected externally from the housing 100 through the exit port 101.

The air flow chamber 331 is formed by a box-shaped member having a covered bottom end and an open top end. The suction device 336 is located under the air flow chamber 331. A bottom wall of the box-shaped member forming the air flow chamber 331 has a gas outlet (not illustrated) corresponding to the suction device 336. The suction device 336 is connected to a power source (not illustrated). Operation of the suction device 336 creates negative pressure in the air flow chamber 331. The negative pressure causes sucking on the sheet P through the conveyor belt 320.

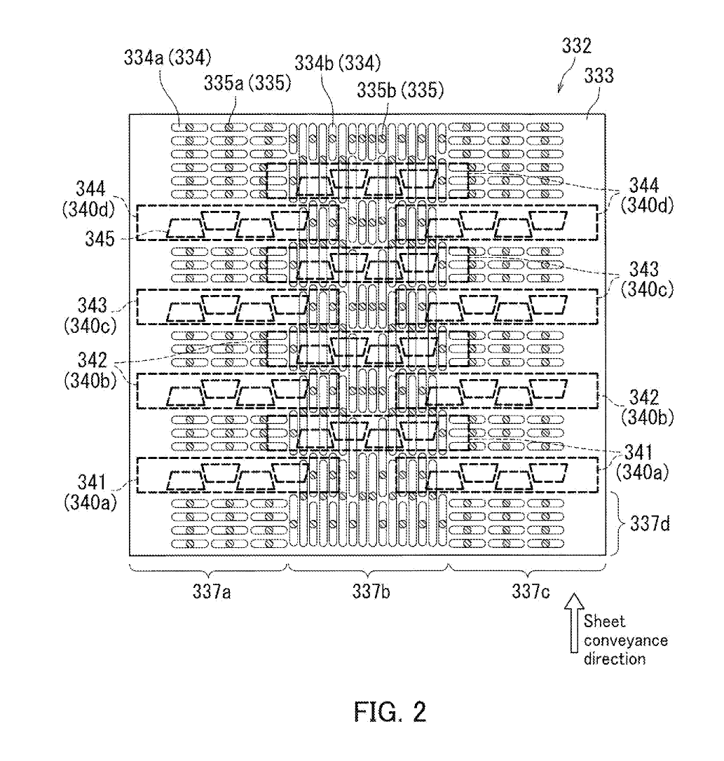

FIG. 2 is a plan view of the guide member 332. FIG. 2 illustrates a positional relationship between the guide member 332 and the four types of line head 340a, 340b, 340c, and 340d. Note that the conveyor belt 320 is not illustrated in FIG. 2 in order to facilitate understanding.

As illustrated in FIG. 2, the line head 340a for black (Bk) includes three recording heads 341. The three recording heads 341 are arranged in the width direction of the guide member 332 (i.e., a direction perpendicular to the sheet conveyance direction) in a staggered formation.

The line head 340b for cyan (C) includes three recording heads 342. The three recording heads 342 are arranged in the width direction of the guide member 332 (i.e., the direction perpendicular to the sheet conveyance direction) in a staggered formation.

The line head 340c for magenta (M) includes three recording heads 343. The three recording heads 343 are arranged in the width direction of the guide member 332 (i.e., the direction perpendicular to the sheet conveyance direction) in a staggered formation.

The line head 340d for yellow (Y) includes three recording heads 344. The three recording heads 344 are arranged in the width direction of the guide member 332 (i.e., the direction perpendicular to the sheet conveyance direction) in a staggered formation.

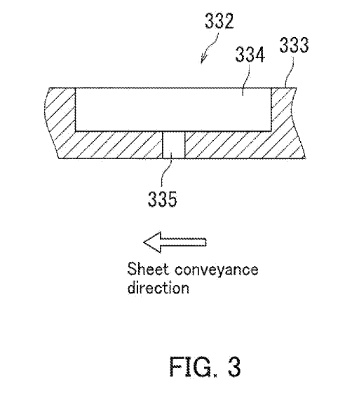

The guide member 332 has a surface 333 facing the line heads 340a, 340b, 340c, and 340d (the recording heads 341-344) and having a plurality of grooves 334 therein. The surface 333 is hereinafter referred to as an obverse surface 333. The obverse surface 333 faces the line heads 340a, 340b, 340c, and 340d (the recording heads 341-344). The grooves 334 include first grooves 334a and second grooves 334b. The first grooves 334a each have a rod-like shape with rounded ends that extends in a direction across the sheet conveyance direction. In the first embodiment, the first grooves 334a each have a rod-like shape with rounded ends that extends in a direction perpendicular to the sheet conveyance direction (i.e., the width direction of the guide member 332). The second grooves 334s each have a rod-like shape with rounded ends that extends in the sheet conveyance direction. FIG. 3 is a cross sectional view illustrating a groove 334 and a through hole 335 of the guide member 332. As illustrated in FIGS. 2 and 3, for each of the plurality of grooves 334, the guide member 332 has a corresponding through hole 335 that runs through the guide member 332 in a thickness direction thereof. Each of the through holes 335 has a circular cross section.

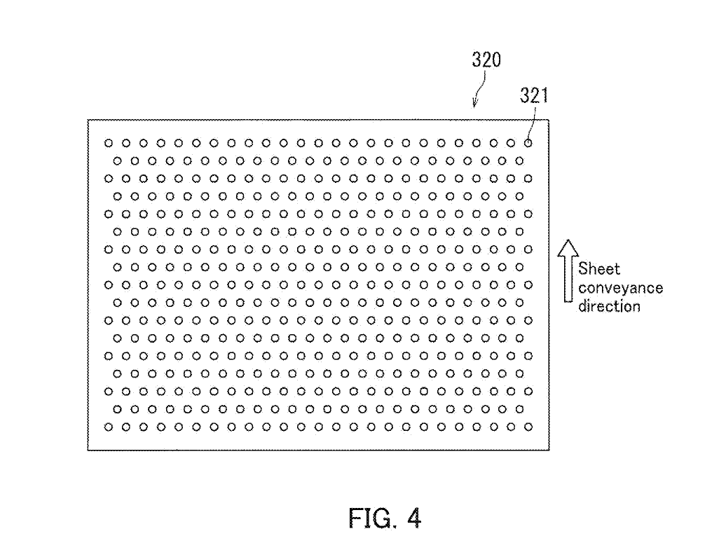

FIG. 4 is a plan view illustrating the conveyor belt 320. As illustrated in FIG. 4, the conveyor belt 320 has a plurality of suction holes 321 perforated therethrough. The suction holes 321 are arranged in a staggered formation.

The air flow chamber 331 (see FIG. 1) is in communication with the suction holes 321 (see FIG. 4) in the conveyor belt 320 through the through holes 335 (see FIG. 2) and the grooves 334 (see FIG. 2) in the guide member 332.

[Operation of Inkjet Recording Apparatus 1]

The following explains operation of the inkjet recording apparatus 1 with reference to FIG. 1. A sheet P is picked up from the sheet feed cassette 201 by the sheet feed roller 202. The picked-up sheet P is guided to the first pair of conveyance rollers 402 by the guide plates 203. In a situation in which a plurality of sheets P are stacked in the sheet feed cassette 201, an uppermost sheet P in the stack is picked up from the sheet feed cassette 201 by the sheet feed roller 202.

The sheet P is fed into the sheet conveyance path 401 by the first pair of conveyance rollers 402 and is then conveyed in the sheet conveyance direction by the second pair of conveyance rollers 403. The sheet P stops upon coming into contact with the pair of registration rollers 404. Through the above, skew correction is performed on the sheet P. The sheet P is subsequently fed to the image forming section 300 in synchronization with timing of image formation.

The sheet P is guided and sucked onto on the conveyor belt 320 by the sheet holding roller 312. Preferably the sheet P is guided onto the conveyor belt 320 such that the center of the sheet P in terms of the width direction thereof coincides with the center of the conveyor belt 320 in terms of the width direction thereof. The sheet P covers one or more of the suction holes 321 perforated in the conveyor belt 320. The suction section 330 sucks air (an example of a gas) through the through holes 335 and the grooves 334 in the guide member 332 and the suction holes 321 in the conveyor belt 320. In other words, the suction section 330 creates negative pressure in the air flow chamber 331. The negative pressure acts on the sheet P, thereby causing the sheet P to be sucked onto the conveyor belt 320. The sheet P is conveyed in the sheet conveyance direction as the conveyor belt 320 circulates.

The conveyor belt 320 conveys each portion of the sheet P, in turn, to positions opposite to the four types of line head 340a, 340b, 340c, and 340d (the recording heads 341-344). During the aforementioned conveyance, each of the four types of line head 340a, 340b, 340c, and 340d (the recording heads 341-344) ejects ink droplets of the corresponding color toward the sheet P. Through the above process, an image is formed on the sheet P.

The sheet P is conveyed from the conveyor belt 320 to the conveyance guide 350. Once the sheet P has passed through the conveyance guide 350, the sheet P is fed toward the exit port 101 by the pair of ejection rollers 501 and is guided onto the exit tray 502. As a result, the sheet P is ejected externally from the housing 100 through the exit port 101.

In the line head inkjet recording apparatus 1 explained above, a sheet P is conveyed under the line heads 340a, 340b, 340c, and 340d (the recording heads 341-344). Therefore, the recording rate of the inkjet recording apparatus 1 can be increased by increasing the conveyance speed of the sheet P. For example, the conveyance speed of the sheet P in the inkjet recording apparatus 1 can be set at 900 mm/s. Also, in a situation in which A4 size sheet P is conveyed with a long edge thereof orientated perpendicularly to the conveyance direction, the inkjet recording apparatus 1 can for example have a printing rate of 150 sheets per minute.

[Configuration of Guide Member 332]

As illustrated in FIG. 2, the guide member 332 has the first grooves 334a into the obverse surface 333 thereof. First through holes 335a are each located in a corresponding one of the grooves 334a. In the configuration as above, even upon occurrence of meandering of the conveyor belt 320, the suction holes 321 of the conveyor belt 320 can hardly deviate from the grooves 334 (the first grooves 334a) of the guide member 332.

In a configuration in which the grooves in a guide member include only grooves that extend in the sheet conveyance direction, meandering of the conveyor belt may tend to cause the suction holes of the conveyor belt to deviate from the grooves of the guide member. Even if meandering of the conveyor belt is corrected, inaccurate correction (posture of the conveyor belt deviated from a predetermined posture) may cause the suction holes of the conveyor belt to deviate from the grooves of the guide member. The suction holes of the conveyor belt may also deviate from the grooves of the guide member during the time when meandering correction is performed on the conveyor belt.

When the suction holes of the conveyor belt deviate from the grooves of the guide member, the suction force acting on a sheet (suction force for holding a sheet on the conveyor belt) may immediately reduce to cause the sheet to lift up. By contrast, the suction holes 321 of the conveyor belt 320 in the first embodiment can hardly deviate from the grooves 334 (the first grooves 334a) of the guide member 332, thereby hardly causing lift up of the sheet P.

Further in first embodiment, the first grooves 334a are located in the opposite end portions (the first and second end portions 337a and 337c) of the guide member 332. The first and second end portions 337a and 337c of the guide member 332 are regions where the edges of the sheet P pass (edges thereof oriented perpendicularly to the sheet conveyance direction). In the above configuration, even when a sheet P is displaced in the width direction of the guide member 332 (i.e., the width direction of the conveyor belt 320), the edges of the sheet P can hardly come off from the grooves 334 (the first grooves 334a) of the guide member 332. Thus, lift off of the sheet P can be prevented.

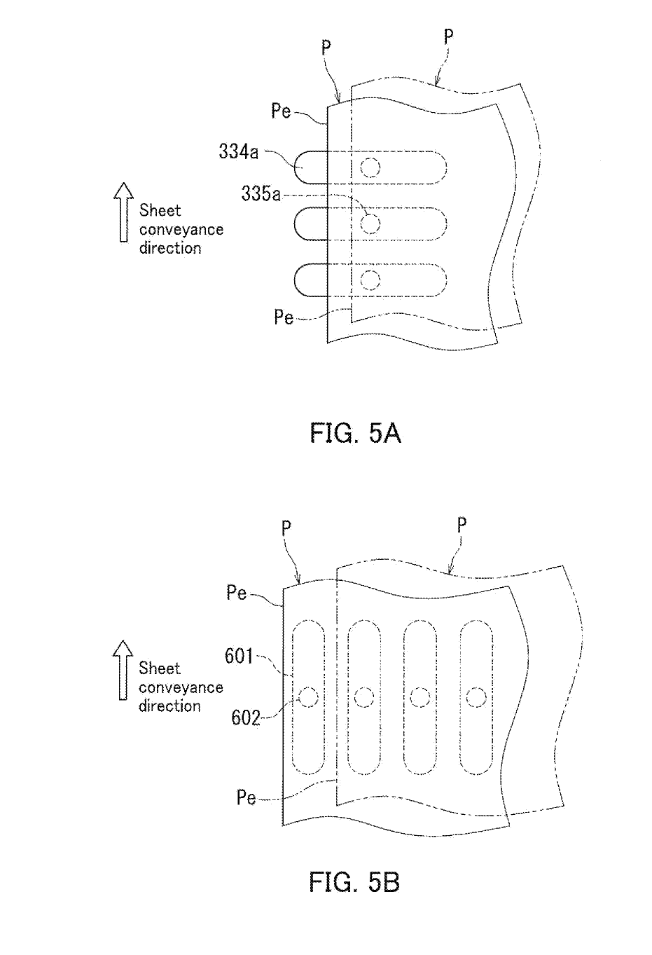

Advantages with respect to the first grooves 334a located in the opposite end portions (the first and second end portions 337a and 337c) of the guide member 332 will be explained next with reference to FIG. 5 by referring to first grooves 334a located in one (the first end portion 337a) of the end portions of the guide member 332.

FIG. 5A illustrates a positional relationship between a sheet P and the first grooves 334a located in the first end portion 337a of the guide member 332. FIG. 5B illustrates a positional relationship between a sheet P and grooves 601 located in one of end portions of a typical guide member. The grooves 601 each have a rod-like shape with rounded ends that extends in the sheet conveyance direction and are each in communication with a corresponding one of through holes 602 in the guide member. The grooves 601 correspond to the grooves 334 in the present embodiment, and the through holes 602 correspond to the through holes 335 in the present embodiment.

As illustrated in FIG. 5B, in a configuration in which grooves located in the end portion of the guide member are only the grooves 601 that extend in the sheet conveyance direction, an edge Pe of the sheet P may tend to come off from a groove 601 in the guide member when the sheet P is displaced in the direction perpendicular to the sheet conveyance direction. Coming off of the edge Pe of the sheet P from a groove 601 of the guide member may lift up the edge Pe of the sheet P. By contrast, as illustrated in FIG. 5A, even when the sheet P is displaced in the direction perpendicular to the sheet conveyance direction, the edge Pe of the sheet P can hardly come off from the first grooves 334a in the guide member 332 in the first embodiment. Thus, the edges Pe of the sheet P can be prevented from lifting up.

Note that the first and second end portions 337a and 337c of the guide member 332 are set in agreement with respective edges Pe of a sheet P having a size within which the inkjet recording apparatus 1 can form an image. In a configuration in which the first and second end portions 337a and 337c of the guide member 332 can be set in agreement with not all edges of sheets having sizes within which the inkjet recording apparatus 1 can form an image, the first and second end portions 337a and 337c of the guide member 332 are set in agreement with respective edges of a sheet having a size that is the most commonly available, for example, a fixed size sheet.

Further in the first embodiment, the second grooves 334b are located in the central portion 337b of the guide member 332 and the respective through holes 335b are located the respective second grooves 334b, as illustrated in FIG. 2. The central portion 337b of the guide member 332 is a region between the first and second end portions 337a and 337c of the guide member 332.

Each of the first grooves 334a extends in the direction perpendicular to the sheet conveyance direction, so that friction in the sheet conveyance direction tends to be generated between the conveyor belt 320 and edges of the first grooves 334a. For this reason, in a configuration in which the first grooves 334a are located all over the entire obverse surface 333 of the guide member 332, unevenness in conveyance speed may occur. By contrast, in the first embodiment, the second grooves 334b are located in the obverse surface 333 of the guide member 332. Thus, unevenness in conveyance speed can be reduced.

Note that in the configuration with the second grooves 334b, it is preferable that the first grooves 334a are arranged in the first and second end portions 337a and 337c of the guide member 332 and the second grooves 334b are arranged in the central portion 337b of the guide member 332 in order to prevent lift up of the edges of the sheet P.

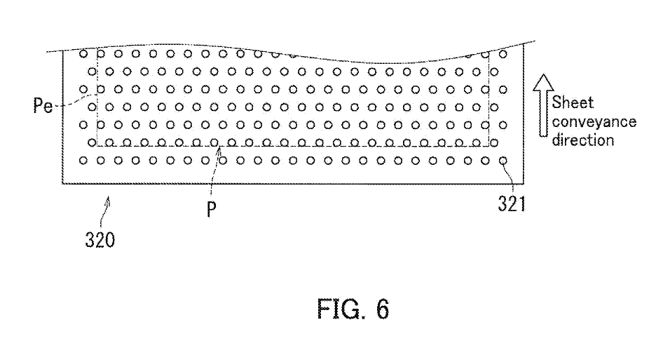

FIG. 6 illustrates an example of a positional relationship between the suction holes 321 in the conveyor belt 320 and edges Pe of a sheet P according to the present embodiment. As illustrated in FIG. 6, at least one or more of the suction holes 321 in the conveyor belt 320 are preferably arranged in respective portions thereof that correspond to the respective edges Pe of the sheet P. This can prevent lifting up of the edges Pe of the sheet P. For example, at least one or more of the suction holes 321 opposite to the first and second end portions 337a and 337c of the guide member 332 are located in portions of the conveyor belt 320 that correspond to the edges Pe of the sheet P. In a configuration in which the suction holes 321 of the conveyor belt 320 can be arranged in portions thereof that correspond to not all edges of sheets having sizes within which the inkjet recording apparatus 1 can form an image, the suction holes 321 are arranged in portions of the conveyor belt 320 that correspond to respective edges Pe of a sheet P having a size that is the most commonly available, for example, a fixed size sheet.

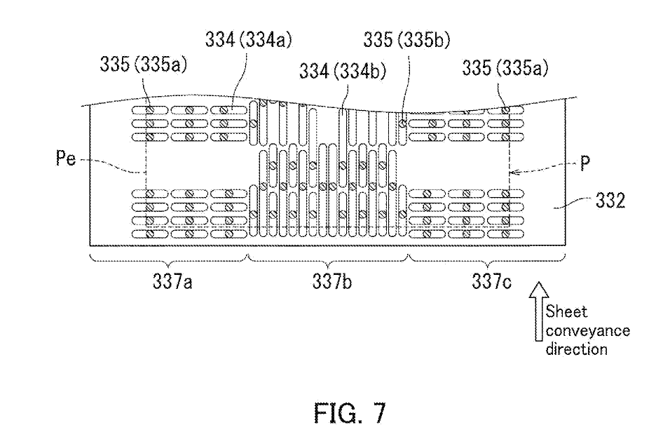

FIG. 7 illustrates an example of a positional relationship between the through holes 335 in the guide member 332 and edges Pe of a sheet P according to the present embodiment. At least one or more of the through holes 335 of the guide member 332 are preferably arranged in respective portions thereof that correspond to the edges Pe of the sheet P. The above configuration can prevent lift up of the edges Pe of the sheet P. For example, as illustrated in FIG. 7, at least one or more of the first through holes 335a of the first and second end portions 337a and 337c of the guide member 332 are arranged in respective portions thereof that correspond to the respective edges Pe of the sheet P. In a configuration in which the through holes 335 of the guide member 332 can be arranged in portions thereof that correspond to not all edges of sheets having sizes within which the inkjet recording apparatus 1 can form an image, the through holes 335 are arranged in portions of the guide member 332 that correspond to the respective edges Pe of a sheet P having a size that is the most commonly available, for example, a fixed size sheet.

As illustrated in FIG. 2, each head surface of the recording heads 341, 342, 343, and 344 that faces the conveyor belt 320 includes ejection regions 345. Nozzle orifices are located in the ejection region 345.

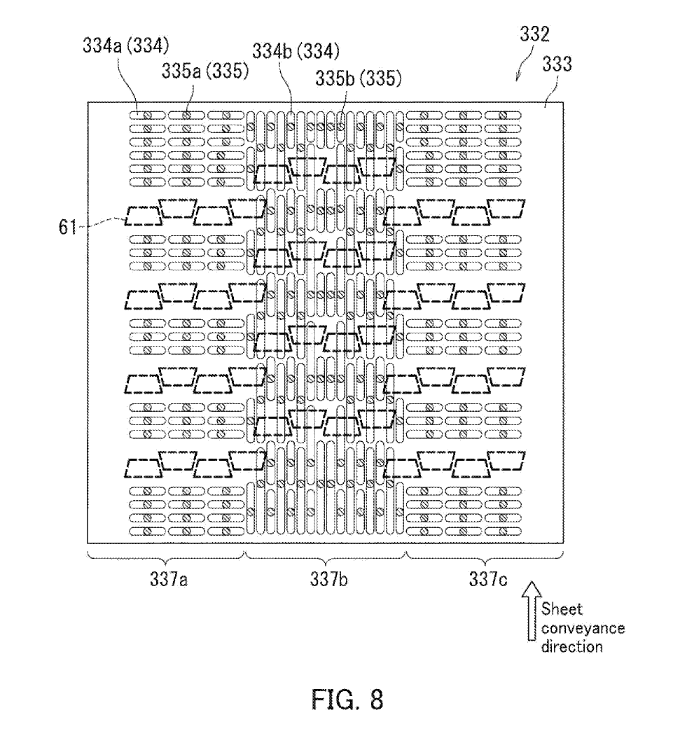

FIG. 8 is a plan view illustrating the guide member 332 according to the present embodiment. As illustrated in FIG. 8, the through holes 335 in the first embodiment are located outside of nozzle facing regions 61 of the guide member 332. The nozzle facing regions 61 each face corresponding one of the ejection regions 345 of the recording heads 341, 342, 343, and 344 explained with reference to FIG. 2. In the above configuration, landing deviation of ink droplets can be hardly caused that may be caused by suction air flow generated below the recording heads 341, 342, 343, and 344. The suction air flow is generated by air suction toward the air flow chamber 331 through the grooves 334 and the through holes 335 of the guide member 332 and through the suction holes 321 of the conveyor belt 320.

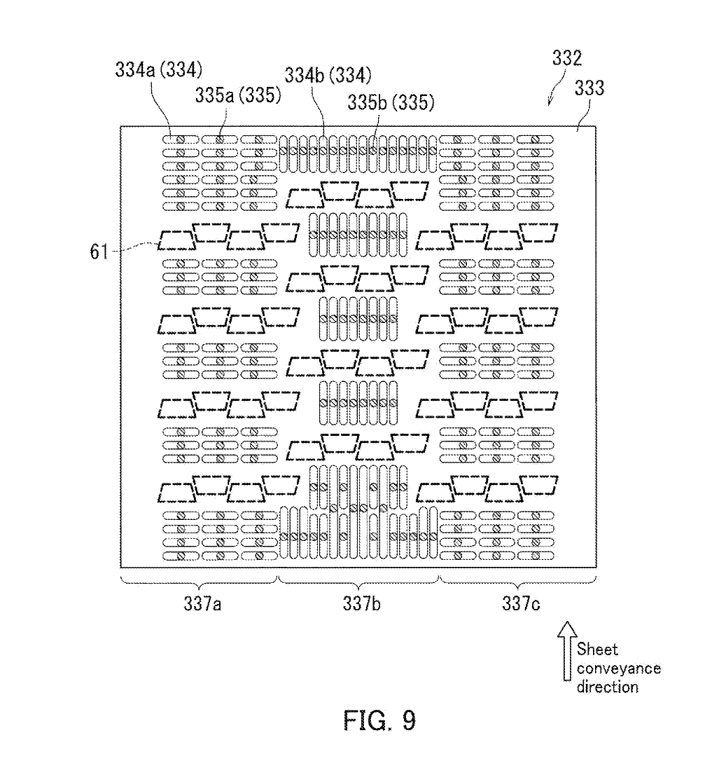

Landing deviation of droplets caused by the suction air flow can be more hardly caused by locating the grooves 334 outside of the respective nozzle facing regions 61 (respective regions of the guide member 332 that face the respective ejection regions 345). FIG. 9 is a plan view illustrating a variation of the guide member 332. The guide member 332 illustrated in FIG. 9 has the grooves 334 outside of the respective nozzle facing regions 361. In the above configuration, the landing deviation of ink droplets that may be caused by suction air flow can be hardly caused.

The first grooves 334a are preferably located in an upstream region 337d of the guide member 332 in terms of the sheet conveyance direction (a region where the sheet P comes over the guide member 332). Positional displacement of the sheet P in the direction perpendicular to the sheet conveyance direction tends to occur when the sheet P comes over the guide member 332. However, the first grooves 334a in the upstream region 337d of the guide member 332 in terms of the sheet conveyance direction (a region where the sheet P comes over the guide member 332) can ensure that the conveyor belt 320 reliably holds the sheet P, thereby preventing positional displacement of the sheet P in the direction perpendicular to the sheet conveyance direction. Thus, the edges of the sheet P can be prevented from lifting up.

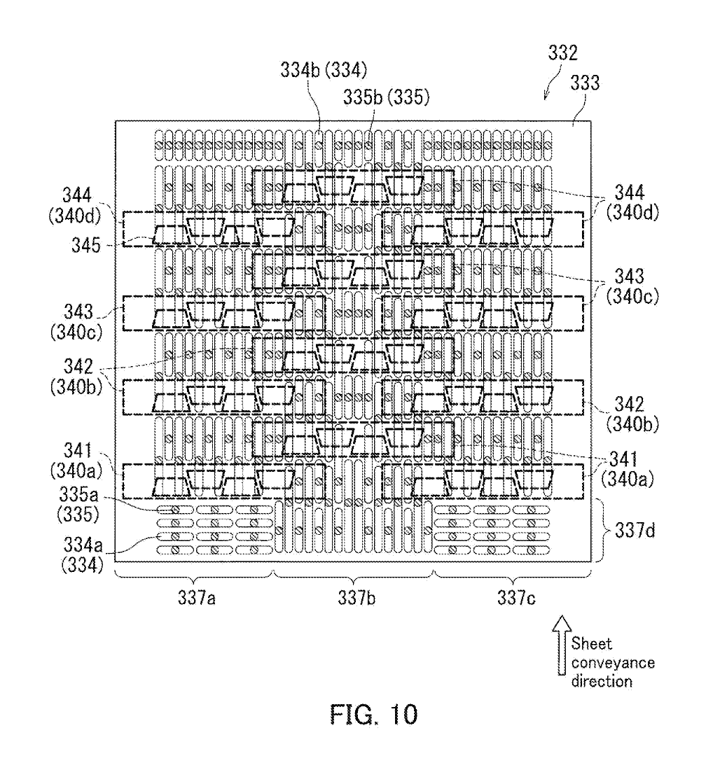

FIG. 10 is a plan view illustrating another variation of the guide member 332. The first grooves 334 in the guide member 332 illustrated in FIG. 10 are located in only a region located in the upstream region 337d of the guide member 332 in terms of the sheet conveyance direction. Even the above configuration can ensure that the conveyor belt 320 reliably holds the sheet P, thereby preventing positional displacement of the sheet P in the direction perpendicular to the sheet conveyance direction. Thus, the edges of the sheet P can be prevented from lifting up.

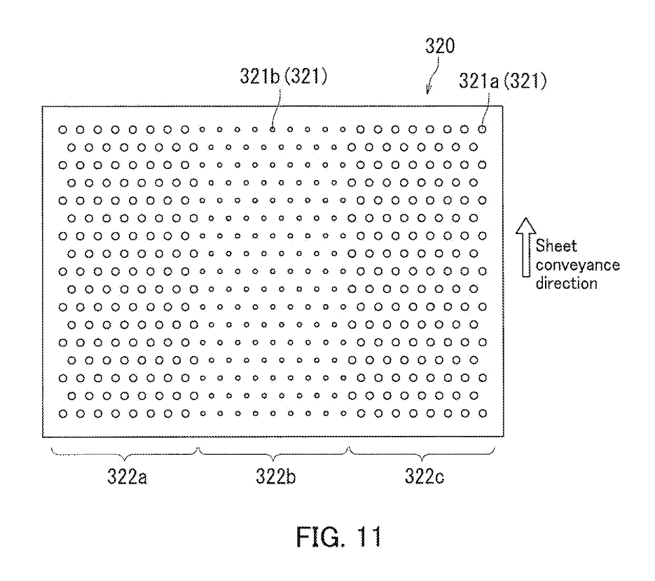

A variation of the conveyor belt 320 will be described next. FIG. 11 is a plan view illustrating a variation of the conveyor belt 320. The conveyor belt 320 illustrated in FIG. 11 has first suction holes 321a and second suction holes 321b among the suction holes 321. The first suction holes 321a are located in the opposite end portions (the first and second end portions 322a and 322c) of the conveyor belt 320. The second suction holes 321b are located in a central portion 322b of the conveyor belt 320. The first and second end portions 322a and 322c in the conveyor belt 320 are regions where the edges of a sheet P are placed (loaded). The first and second end portions 322a and 322c of the conveyor belt 320 accordingly face the first and second end portions 337a and 337c of the guide member 332, respectively. The central portion 322b of the conveyor belt 320 is a region between the first and second end portions 322a and 322c of the conveyor belt 320. The central portion 322b of the conveyor belt 320 accordingly faces the central portion 337b of the guide member 332.

The first suction holes 321a each have an area greater than each of the second suction holes 321b in the conveyor belt 320 illustrated in FIG. 11. With the above configuration, even upon occurrence of meandering of the conveyor belt 320, the suction holes 321 (the first suction holes 321a) located in the first and second end portions 322a and 322c of the conveyor belt 320 can hardly deviate from the grooves 334 (the first grooves 334a) of the guide member 332. Thus, the edges of the sheet P can be prevented from lifting up. Further, even if the sheet P is displaced in the direction perpendicular to the sheet conveyance direction, the edges of the sheet P can hardly come off from the suction holes 321 (the first suction holes 321a) in the first and second end portions 322a and 322c of the conveyor belt 320. Thus, the edges of the sheet P can be prevented from lifting up.

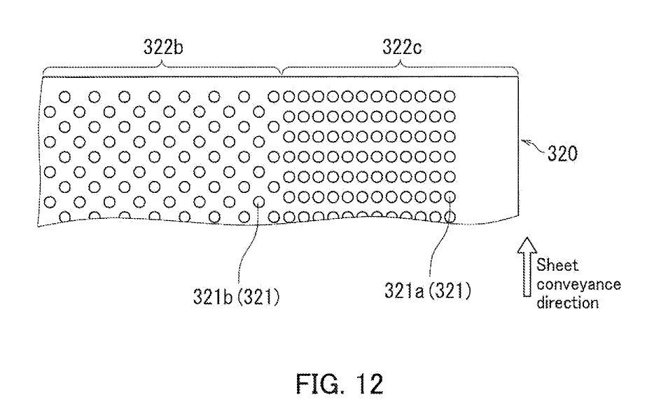

FIG. 12 is a plan view illustrating another variation of the conveyor belt 320. Specifically, FIG. 12 is an enlarged view of a section of the conveyor belt 320 in another variation. In the conveyor belt 320 illustrated in FIG. 12, the number density of the suction holes 321 (the first suction holes 321a) in the first and second end portions 322a and 322c of the conveyor belt 320 is higher than that of the suction holes 321 (the second suction holes 321b) in the central portion 322b of the conveyor belt 320.

In the above configuration, the suction holes 321 (the first suction holes 321a) in the first and second end portions 322a and 322c of the conveyor belt 320 can hardly deviate from the grooves 334 (the first grooves 334a) in the guide member 332 even upon occurrence of meandering of the conveyor belt 320. Thus, the edges of the sheet P can be prevented from lifting up. Further, even when the sheet P is displaced in the direction perpendicular to the sheet conveyance direction, the edges of the sheet P can hardly come off from the suction holes 321 (the first suction holes 321a) in the first and second end portions 322a and 322c of the conveyor belt 320. Thus, the edges of the sheet P can be prevented from lifting up.

### Second Embodiment

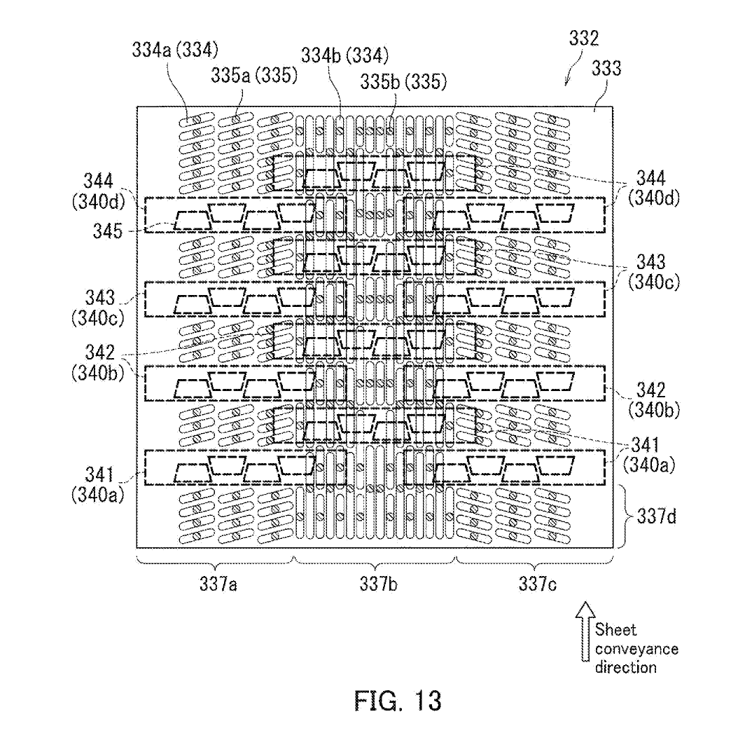

Following explains a second embodiment of the present disclosure. FIG. 13 is a plan view illustrating a guide member 332 according to the second embodiment of the present disclosure. The second embodiment only differs from the first embodiment in terms of configuration of the guide member 332. The following explains the second embodiment based on differences compared to the first embodiment and omits explanation of matter that is the same as for the first embodiment.

In the second embodiment, the first grooves 334a incline relative to the sheet conveyance direction. As explained in the first embodiment, the grooves that extend in the direction perpendicular to the sheet conveyance direction may cause unevenness in conveyance speed. By contrast, the first grooves 334a in the second embodiment incline relative to the sheet conveyance direction. Therefore, friction in the sheet conveyance direction may be hardly generated between the conveyor belt 320 and edges of the first grooves 334a. Thus, unevenness in conveyance speed can be reduced.

Further, in a configuration in which the first grooves 334a inclining relative to the sheet conveyance direction are arranged all over the entire obverse surface 333 of the guide member 332, unevenness in conveyance speed may occur. By contrast, the guide member 332 in the second embodiment has the second grooves 334b into the obverse surface 333 thereof, thereby reducing unevenness in conveyance speed.

Further in the second embodiment, the suction holes 321 in the conveyor belt 320 can hardly deviate from the grooves (the first grooves 334a) of the guide member 332 even upon occurrence of meandering of the conveyor belt 320, in the same way as explained for the first embodiment. Thus, the edges of the sheet P can be prevented from lifting up.

In addition, in the second embodiment, even the sheet P is displaced in the direction perpendicular to the sheet conveyance direction, the edges of the sheet P can hardly come off from the grooves 334 (the first grooves 334a) of the guide member 332. Thus, the edges of the sheet P can be prevented from lifting up.

Preferably, at least one or more of the suction holes 321 in the conveyor belt 320 are arranged in portions thereof that correspond to the edges of the sheet P, in the same way as explained for the first embodiment. Thus, the edges of the sheet P can be prevented from lifting up.

Preferably, at least one or more of the through holes 335 of the guide member 332 are arranged in portions thereof that correspond to the edges of the sheet P, in the same way as explained for the first embodiment. Thus, the edges of the sheet P can be prevented from lifting up.

In the same way as explained for the first embodiment, the through holes 335 are located outside of the respective regions (the nozzle facing regions 61) of the guide member 332 that face the ejection regions 345 of the respective recording heads 341, 342, 343, and 344. The above configuration can prevent landing deviation of ink droplets caused by suction air flow.

Alternatively, in the same way as explained for the first embodiment, the grooves 334 may be located outside of the respective regions (the nozzle facing regions 61) of the guide member 332 that face the ejection regions 345 of the respective recording heads 341, 342, 343, and 344 in the second embodiment. The above configuration can more favorably prevent landing deviation of ink droplets caused by suction air flow.

The first grooves 334a are preferably located in the upstream region 337d of the guide member 332 in terms of the sheet conveyance direction (a region where the sheet P comes over the guide member 332), in the same way as explained for the first embodiment. The above configuration can prevent positional displacement of the sheet p in the direction perpendicular to the sheet conveyance direction, thereby preventing lift up of the edges of the sheet P.

Yet, in the same way as explained for the first embodiment, the first grooves 334a may be located only in the upstream region of the guide member in terms of the sheet conveyance direction. The above configuration can prevent positional displacement of the sheet P in the direction perpendicular to the sheet conveyance direction, thereby preventing lift up of the edges of the sheet P.

Yet further, in the same way as explained for the first embodiment, the suction holes 321 (the first suction holes 321a) located in the first and second end portions 322a and 322c of the conveyor belt 320 each may have an area greater than each of the suction holes 321 (the second suction holes 321b) located in the central portion 322b of the conveyor belt 320. The above configuration can prevent the edges of the sheet P from lifting up.

In the same way as explained for the first embodiment, the number density of the suction holes 321 (the first suction holes 321a) located in the first and second end portions 322a and 322c of the conveyor belt 320 may be higher than that of the suction holes 321 (the second suction holes 321b) located in the central portion 322b of the conveyor belt 320. This can prevent the edges of the sheet P from lifting up.

Besides, any appropriate combinations of the features in the first and second embodiments are possible.

Specific embodiments of the present disclosure are explained above, but the present disclosure is of course not limited to the above embodiments and various alterations can be made to the embodiments.

For example, the through holes 335 each have a circular shape in cross section in the above embodiments. However, the shape of each of the through holes 335 is not limited to being circular in cross section. The through hole 335 each may have a rectangular cross-section, for example.

The embodiments have been explained for a situation in which the present disclosure is applied to a line head inkjet recording apparatus, but the present disclosure can also be applied to a serial head inkjet recording apparatus.

In the embodiments, three recording heads are arranged for each color in a staggered formation in the direction perpendicular to the sheet conveyance direction, but there is no particular limitation on the number of recording heads for each of the colors. For example, a single recording head may be provided for each of the colors. Also, in a configuration in which a plurality of recording heads are provided for each of the colors, the plurality of recording heads for each of the colors are not limited to being arranged in a staggered formation and may instead be arranged in a single line in the direction perpendicular to the sheet conveyance direction.

The embodiments have been explained for a situation in which the present disclosure is applied to an inkjet recording apparatus that is capable of forming a full-color image, but the present disclosure can also be applied to an inkjet recording apparatus that forms a monochrome image.

Although the embodiments are explained for a situation in which the present disclosure is applied to an inkjet recording apparatus, the present disclosure can also be applied to other image forming apparatuses (e.g., an electrophotographic image forming apparatus).

Furthermore, although the embodiments are explained for a situation in which the recording medium is a sheet of paper, the recording medium may be a medium other than a sheet of paper (e.g., a resin sheet or cloth).

In addition to the alterations explained above, a wide range of other alterations can be made to the embodiments so long as such alterations do not deviate from the intended scope of the present disclosure.

What is claimed is:

1. A conveyor device for installation opposite to a recording head in a recording apparatus, comprising:
a conveyor belt configured to convey a recording medium; and
a suction section configured to suck on the recording medium through the conveyor belt and a guide member of the suction section that is located opposite to the recording head with the conveyor belt therebetween, the guide member having a plurality of through holes, wherein
the guide member has a surface having a plurality of grooves therein and facing the recording head with the conveyor belt therebetween,
the respective through holes are located in the respective grooves, and
the grooves include a plurality of first grooves that extend in a direction across a conveyance direction of the recording medium.

2. The conveyor device according to claim 1, wherein
the grooves include a plurality of second grooves that extend in the conveyance direction of the recording medium,
the first grooves are located in opposite end portions of the guide member in terms of a direction perpendicular to the conveyance direction of the recording medium, and
the second grooves are located in a central portion of the guide member in terms of the direction perpendicular to the conveyance direction of the recording medium.

3. The conveyor device according to claim 1, wherein
the conveyor belt has a plurality of suction holes.

4. The conveyor device according to claim 3, wherein
the suction holes of the conveyor belt include a plurality of first suction holes and a plurality of second suction holes,
the first suction holes are located in opposite end portions of the conveyor belt in terms of a direction perpendicular to the conveyance direction of the recording medium,
the second suction holes are located in a central portion of the conveyor belt in terms of the direction perpendicular to the conveyance direction of the recording medium, and
the first suction holes each have an area greater than each of the second suction holes.

5. The conveyor device according to claim 3, wherein
the suction holes of the conveyor belt include a plurality of first suction holes and a plurality of second suction holes,
the first suction holes are located in opposite end portions of the conveyor belt in terms of a direction perpendicular to the conveyance direction of the recording medium,
the second suction holes are located in a central portion of the conveyor belt in terms of the direction perpendicular to the conveyance direction of the recording medium, and
a number density of the first suction holes is higher than that of the second suction holes.

6. The conveyor device according to claim 4, wherein
a number density of the first suction holes is higher than that of the second suction holes in the conveyor belt.

7. The conveyor device according to claim 3, wherein
at least one or more of the suction holes are arranged in portions of the conveyor belt that correspond to edges of the recording medium in terms of a direction perpendicular to the conveyance direction of the recording medium.

8. The conveyor device according to claim 1, wherein
one or more of the through holes are located in portions of the guide member that correspond to edges of the recording medium in terms of a direction of perpendicular to the conveyance direction of the recording medium.

9. The conveyor device according to claim 1, wherein
the first grooves of the guide member are located in an upstream region of the guide member in terms of the conveyance direction of the recording medium.

10. The conveyor device according to claim 1, wherein
the through holes of the guide member are located outside of a nozzle facing region of the guide member that faces an ejection region of the recording head.

11. The conveyor device according to claim 1, wherein
the grooves of the guide member are located outside of a nozzle facing region of the guide member that faces an ejection region of the recording head.

12. An inkjet recording device comprising:
the conveyor device according to claim 1; and
the recording head,
wherein the recording head ejects ink droplets.
